(19) United States
(12) Patent Application Publication
(10) Pub. No.: US 2024/0428699 A1
(43) Pub. Date: Dec. 26, 2024

(54) LANGUAGE INSTRUCTION CUSTOMIZATION FOR INDIVIDUAL USERS

(71) Applicant: IMPULSA CO., Wilmington, DE (US)

(72) Inventor: Diego Jose Salvatierra Della-Schiava, Wilmington, DE (US)

(21) Appl. No.: 18/748,703

(22) Filed: Jun. 20, 2024

Related U.S. Application Data
(60) Provisional application No. 63/521,972, filed on Jun. 20, 2023.

(51) Int. Cl. G09B 5/02; G10L 15/187

(52) U.S. Cl. CPC G09B 5/02; G10L 15/187

(57) ABSTRACT

A computing device may receive input from a user indicating a set of target words to be learned. The computing device may fit the set of target words into a grammatical structure of a sentence in the target language. The computing device may generate a sentence in the target language that uses the selected words in a grammatical order, including any necessary conjugations, particles, and articles. The computing device may receive a recording of the user speaking the generated sentence. The computing device may determine that the user has correctly pronounced the sentence using an artificial intelligence model. The computing device may store the correctly pronounced sentence in a personal list of saved sentences.

### CROSS-REFERENCE TO RELATED APPLICATIONS

The present application claims priority to U.S. Prov. App. 63/521,972 filed Jun. 20, 2023, the disclosure of which is incorporated herein by reference for all purposes.

### BACKGROUND

Typical digital language learning applications are designed to provide a structured learning experience for users, often focusing on predetermined sentences and preselected vocabulary. These applications may use flashcards, quizzes, or other interactive tools to help users memorize and practice vocabulary and grammar rules.

### SUMMARY

The present disclosure presents new and innovative systems and methods for language instruction customization for individual users. In some aspects, the techniques described herein relate to a method including: receiving input from a user indicating a set of target words to be learned; fitting the set of target words into a grammatical structure of a sentence in the target language; generating a sentence in the target language that uses the selected words in a grammatical order, including any necessary conjugations, particles, and articles; receiving a recording of the user speaking the generated sentence; determining that the user has correctly pronounced the sentence using an artificial intelligence model; and storing the correctly pronounced sentence in a personal list of saved sentences.

In some aspects, the techniques described herein relate to a method, further including: providing the user with guidance to say the generated sentence, including providing computer-generated voice pronunciation of the generated sentence for the user to mimic.

In some aspects, the techniques described herein relate to a method, further including: providing the user with a word bank of words in the target language; and allowing the user to add additional words to the word bank as needed by inputting them.

In some aspects, the techniques described herein relate to a method, wherein the grammatical structure of the sentence includes at least a subject, a verb, and a noun.

In some aspects, the techniques described herein relate to a method, wherein the generated sentence is automatically displayed as soon as the set of target words are selected.

In some aspects, the techniques described herein relate to a method, wherein the user is guided to practice saying the generated sentence multiple times until the sentence is correctly pronounced.

In some aspects, the techniques described herein relate to a method, wherein the artificial intelligence model determines if the user has correctly pronounced the sentence by comparing the user's pronunciation to an expected pronunciation of the sentence.

In some aspects, the techniques described herein relate to a method, wherein the personal list of saved sentences forms a digital phrasebook for the user.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a language learning interface according to one aspect of the present disclosure.

FIG. 2 illustrates a method according to one aspect of the present disclosure.

FIG. 3 illustrates a computing device according to one aspect of the present disclosure.

### DETAILED DESCRIPTION OF EXAMPLE EMBODIMENTS

Conventional digital language learning applications may typically be limited to predetermined sentences and preselected vocabulary. Users of these applications are limited to learning only the sentences and vocabulary pre-loaded onto the application, which may not be what the users are interested in learning. Additionally, conventional applications may not provide personalized learning experiences that cater to the specific needs and interests of each individual user. Relatedly, existing language learning applications often rely on flashcards or physical phrasebooks, which can be cumbersome and difficult to use. These traditional methods may not provide a comprehensive learning experience, as they do not allow users to practice constructing their own sentences using the vocabulary they want to learn. Therefore, there exists a need to provide language learning services (such as computer-based language learning services) such that in a customized manner to meet the needs of individual users.

One solution to these problems is to generate customized sentences in a target language based on user-selected, or user-specific, terminology. For example, users may select the words they want to learn and personalized sentences may be generated for the users to practice these words. In particular, users may select words from a word bank for one or more sentences they wish to learn in a target language. The words may be assembled into a grammatical structure and a sentence containing the words may be determined in the target language. Generating the sentence may include adding any conjugations or other particles and articles that may be necessary to form a grammatically complete sentence. Users may then practice saying the sentence and may be guided by computer-generated voice pronunciation. The sentence may be saved in a personal list of saved sentences, forming a digital phrasebook for the user.

In certain aspects, artificial intelligence and/or machine learning models may be used, such as to generate the sentence, provide guidance to the user, and/or to determine if the user has correctly pronounced the sentence. For example, a model may compare the user's pronunciation to a pre-recorded correct pronunciation of the sentence to determine if the user has pronounced the sentence correctly. The user may be guided to practice saying the generated sentence multiple times until they correctly pronounce the sentence.

In certain aspects, these techniques may be implemented using a system. The system may include a computing device. The computing device may be configured to generate personalized language learning sentences. The computing device may receive input from a user indicating a set of target words to be learned in a target language. The target words may be selected from a word bank that includes preloaded vocabulary and allows the user to add additional words. The computing device may form the selected words into a grammatical structure of a sentence in the target language. The grammatical structure may include at least a subject, a verb, and a noun. Once the grammatical structure is complete, the computing device may generate a sentence in the target language that uses the selected words in the correct grammatical order, including any necessary conjugations, particles, and articles.

The computing device may provide the user with guidance to speak the generated sentence. Guidance may include providing computer-generated voice pronunciation of the generated sentence for the user to mimic when speaking the sentence. The user may be guided to practice saying the generated sentence multiple times until the sentence is correctly pronounced. The computing device may also receive a recording of the user speaking the generated sentence and may determine if the user has correctly pronounced the sentence using a machine learning model. For example, the machine learning model may determine if the user has correctly pronounced the sentence by comparing the user's pronunciation to an expected pronunciation of the sentence. If the user pronounces the sentence correctly, the computing device stores the correctly pronounced sentence in a personal list of saved sentences, forming a digital phrasebook for the user to reference in the future.

The computing device may also automatically generate and display sentence as soon as the target words are received (such as without having to interact with a “Ready” button or other user interface element.

In certain implementations, the target language may be selected from a group consisting of English, Spanish, French, German, Chinese, Japanese, and Korean. In certain implementations, the user may select a difficulty level for the generated sentences. The difficulty level may be based on the complexity of the grammatical structure and vocabulary used in the sentence. the generated sentences may be sourced from a database of pre-existing sentences in the target language. The user may be able to customize the generated sentences by selecting specific grammatical structures or vocabulary to be included in the sentence. The user may also be provided with a visual aid, such as an image or video, to assist in understanding the meaning of the generated sentence.

Additional details are provided in Appendix A, which is provided in conjunction with the present disclosure.

In certain implementations, the computing device described above may be implemented as a general-purpose computer and/or a specialized device designed specifically for language learning. The computing device may include a processor, memory, storage, and input/output devices such as a display, microphone, and speakers. The processor may be configured to execute the instructions that perform the operations described above. The memory is used to store the program code and data needed for the operations (such as the instructions executed by the memory). The storage may store data related to the above operations, such as the preloaded vocabulary, saved sentences, and any other data needed by the program. The input/output devices may be used to interact with the user. The display shows the word bank and generated sentences, and the microphone and speakers are used for recording and playing back the user's voice.

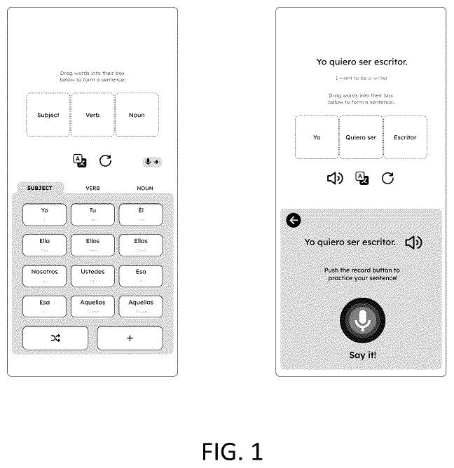

In addition to the computing device described above, the invention may involve data or other information being received from or provided to a user via a user device, which may be separate from the computing device. FIG. 1 provides an example of an interface that may be used to interact with a user via a user device. The user device may be implemented similar to the computing device. Examples user devices may include smartphones, tablets, laptops, desktop computers, wearable devices, and the like.

Communications between the computing device and the user device can occur via a network. Examples of network types include the internet, local area networks (LANs), wide area networks (WANs), cellular networks, and satellite networks. The network interface used for communication can vary depending on the network type. For example, the interface for the internet may be a Wi-Fi or Ethernet connection, while the interface for cellular networks may be a mobile data connection. When the user device is separate from the computing device, the computing device can be configured to send generated sentences and other information to the user device via a network, such as a wired or wireless network.

Overall, the computing device used for this invention can be configured to provide a personalized language learning experience that allows users to select the words they want to learn and generate sentences for them to practice based on those words. The device can include a word bank of preloaded vocabulary and allow the user to add additional words as needed by typing them in. The generated sentences can include at least a subject, a verb, and a noun. The invention can also include a machine learning model to determine if the user has correctly pronounced the sentence and store correctly pronounced sentences in a personal list of saved sentences, forming a digital phrasebook.

In certain aspects, all or part of the above-described techniques may be implemented as a method. Such as a method may be performed by a computing device.

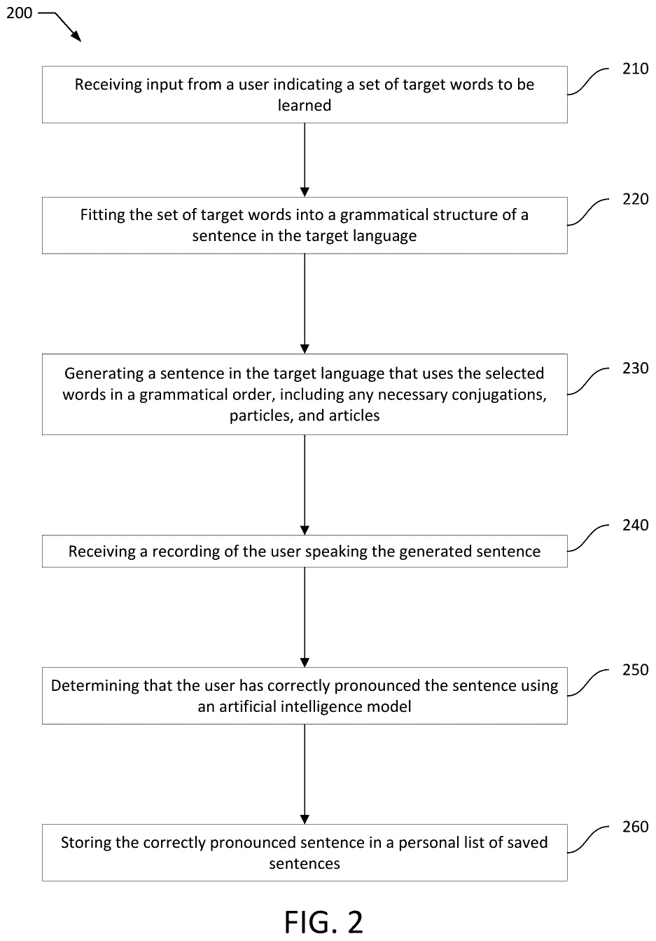

For example, FIG. 2 illustrates a method for language learning customization according to one aspect of the present disclosure. The method 200 may be implemented on a computer system. For example, the method 200 may be implemented by the computing device discussed above. The method 200 may also be implemented by a set of instructions stored on a computer readable medium that, when executed by a processor, cause the computing device to perform the method 200. Although the examples below are described with reference to the flowchart illustrated in FIG. 2, many other methods of performing the acts associated with FIG. 2 may be used. For example, the order of some of the blocks may be changed, certain blocks may be combined with other blocks, one or more of the blocks may be repeated, and some of the blocks may be optional.

The method 200 includes receiving input from a user indicating a set of target words to be learned (block 210). The method 200 also includes fitting the set of target words into a grammatical structure of a sentence in the target language (block 220). The method 200 also includes generating a sentence in the target language that uses the selected words in a grammatical order, including any necessary conjugations, particles, and articles (block 230). The method 200 also includes receiving a recording of the user speaking the generated sentence (block 240). The method 200 also includes determining that the user has correctly pronounced the sentence using a model (block 250). The method 200 also storing the correctly pronounced sentence in a personal list of saved sentences (block 260).

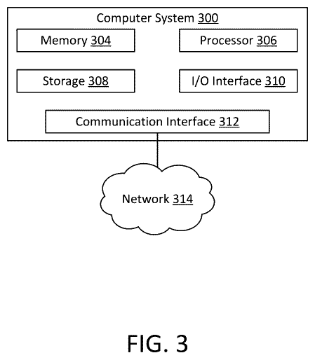

FIG. 3 illustrates an example computer system 300 that may be utilized to implement one or more of the devices and/or components discussed herein, such as the above-discussed computing device. In particular embodiments, one or more computer systems 300 perform one or more steps of one or more methods described or illustrated herein, such as the method 200. In particular embodiments, one or more computer systems 300 provide the functionalities described or illustrated herein. In particular embodiments, software running on one or more computer systems 300 performs one or more steps of one or more methods described or illustrated herein or provides the functionalities described or illustrated herein. Particular embodiments include one or more portions of one or more computer systems 300. Herein, a reference to a computer system may encompass a computing device, and vice versa, where appropriate. Moreover, a reference to a computer system may encompass one or more computer systems, where appropriate.

This disclosure contemplates any suitable number of computer systems 300. This disclosure contemplates the computer system 300 taking any suitable physical form. As example and not by way of limitation, the computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 306, memory 304, storage 308, an input/output (I/O) interface 310, and a communication interface 312. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 306 includes hardware for executing instructions, such as those making up a computer program. As an example and not by way of limitation, to execute instructions, the processor 306 may retrieve (or fetch) the instructions from an internal register, an internal cache, memory 304, or storage 308; decode and execute the instructions; and then write one or more results to an internal register, internal cache, memory 304, or storage 308. In particular embodiments, the processor 306 may include one or more internal caches for data, instructions, or addresses. This disclosure contemplates the processor 306 including any suitable number of any suitable internal caches, where appropriate. As an example and not by way of limitation, the processor 306 may include one or more instruction caches, one or more data caches, and one or more translation lookaside buffers (TLBs). Instructions in the instruction caches may be copies of instructions in memory 304 or storage 308, and the instruction caches may speed up retrieval of those instructions by the processor 306. Data in the data caches may be copies of data in memory 304 or storage 308 that are to be operated on by computer instructions; the results of previous instructions executed by the processor 306 that are accessible to subsequent instructions or for writing to memory 304 or storage 308; or any other suitable data. The data caches may speed up read or write operations by the processor 306. The TLBs may speed up virtual-address translation for the processor 306. In particular embodiments, processor 306 may include one or more internal registers for data, instructions, or addresses. This disclosure contemplates the processor 306 including any suitable number of any suitable internal registers, where appropriate. Where appropriate, the processor 306 may include one or more arithmetic logic units (ALUs), be a multi-core processor, or include one or more processors 306. Although this disclosure describes and illustrates a particular processor, this disclosure contemplates any suitable processor.

In particular embodiments, the memory 304 includes main memory for storing instructions for the processor 306 to execute or data for processor 306 to operate on. As an example, and not by way of limitation, computer system 300 may load instructions from storage 308 or another source (such as another computer system 300) to the memory 304. The processor 306 may then load the instructions from the memory 304 to an internal register or internal cache. To execute the instructions, the processor 306 may retrieve the instructions from the internal register or internal cache and decode them. During or after execution of the instructions, the processor 306 may write one or more results (which may be intermediate or final results) to the internal register or internal cache. The processor 306 may then write one or more of those results to the memory 304. In particular embodiments, the processor 306 executes only instructions in one or more internal registers or internal caches or in memory 304 (as opposed to storage 308 or elsewhere) and operates only on data in one or more internal registers or internal caches or in memory 304 (as opposed to storage 308 or elsewhere). One or more memory buses (which may each include an address bus and a data bus) may couple the processor 306 to the memory 304. The bus may include one or more memory buses, as described in further detail below. In particular embodiments, one or more memory management units (MMUs) reside between the processor 306 and memory 304 and facilitate accesses to the memory 304 requested by the processor 306. In particular embodiments, the memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory implementations, this disclosure contemplates any suitable memory implementation.

In particular embodiments, the storage 308 includes mass storage for data or instructions. As an example and not by way of limitation, the storage 308 may include a hard disk drive (HDD), a floppy disk drive, flash memory, an optical disc, a magneto-optical disc, magnetic tape, or a Universal Serial Bus (USB) drive or a combination of two or more of these. The storage 308 may include removable or non-removable (or fixed) media, where appropriate. The storage 308 may be internal or external to computer system 300, where appropriate. In particular embodiments, the storage 308 is non-volatile, solid-state memory. In particular embodiments, the storage 308 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 308 taking any suitable physical form. The storage 308 may include one or more storage control units facilitating communication between processor 306 and storage 308, where appropriate. Where appropriate, the storage 308 may include one or more storages 308. Although this disclosure describes and illustrates particular storage, this disclosure contemplates any suitable storage.

In particular embodiments, the I/O Interface 310 includes hardware, software, or both, providing one or more interfaces for communication between computer system 300 and one or more I/O devices. The computer system 300 may include one or more of these I/O devices, where appropriate. One or more of these I/O devices may enable communication between a person (i.e., a user) and computer system 300. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 310 may include one or more device or software drivers enabling processor 306 to drive one or more of these I/O devices. The I/O interface 310 may include one or more I/O interfaces 310, where appropriate. Although this disclosure describes and illustrates a particular I/O interface, this disclosure contemplates any suitable I/O interface or combination of I/O interfaces.

In particular embodiments, communication interface 312 includes hardware, software, or both providing one or more interfaces for communication (such as, for example, packet-based communication) between computer system 300 and one or more other computer systems 300 or one or more networks 314. As an example and not by way of limitation, communication interface 312 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 314 and any suitable communication interface 312 for the network 314. As an example and not by way of limitation, the network 314 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 300 may include any suitable communication interface 312 for any of these networks, where appropriate. Communication interface 312 may include one or more communication interfaces 312, where appropriate. Although this disclosure describes and illustrates a particular communication interface implementations, this disclosure contemplates any suitable communication interface implementation.

The computer system 302 may also include a bus. The bus may include hardware, software, or both and may communicatively couple the components of the computer system 300 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCle) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving input from a user indicating a set of target words to be learned;
fitting the set of target words into a grammatical structure of a sentence in the target language;
generating a sentence in the target language that uses the selected words in a grammatical order, including any necessary conjugations, particles, and articles;
receiving a recording of the user speaking the generated sentence;
determining that the user has correctly pronounced the sentence using an artificial intelligence model; and
storing the correctly pronounced sentence in a personal list of saved sentences.

2. The method of claim 1, further comprising:
providing the user with guidance to say the generated sentence, including providing computer-generated voice pronunciation of the generated sentence for the user to mimic.

3. The method of claim 1, further comprising:
providing the user with a word bank of words in the target language; and
allowing the user to add additional words to the word bank as needed by inputting them.

4. The method of claim 1, wherein the grammatical structure of the sentence includes at least a subject, a verb, and a noun.

5. The method of claim 1, wherein the generated sentence is automatically displayed as soon as the set of target words are selected.

6. The method of claim 1, wherein the user is guided to practice saying the generated sentence multiple times until the sentence is correctly pronounced.

7. The method of claim 1, wherein the artificial intelligence model determines if the user has correctly pronounced the sentence by comparing the user's pronunciation to an expected pronunciation of the sentence.

8. The method of claim 1, wherein the personal list of saved sentences forms a digital phrasebook for the user.
